(19) United States
(12) Patent Application Publication
(10) Pub. No.: US 2026/0336198 A1
(43) Pub. Date: Oct. 29, 2026

(54) METHOD FOR IMPRINTING HAND TOOLS AND DEVICE FOR THE SAME

(71) Applicant: Ji-Fen Meng, Taichung City (TW)

(72) Inventor: Ji-Fen Meng, Taichung City (TW)

(21) Appl. No.: 19/188,019

(22) Filed: Apr. 24, 2025

(51) Int. Cl. B29C 59/04; B29C 59/02

(52) U.S. Cl. CPC B29C 59/043; B29C 59/021

(57) ABSTRACT

A hand tool imprinting device and method featuring a mechanical system that ensures precise and consistent imprinting while preventing deformation. The device comprises a base, a slide rail assembly, a positioning assembly with a servo motor and positioning seat, an imprinting assembly with adjustable components, and a control module that coordinates all operations. The method includes seven sequential steps: a preliminary step for mounting the hand tool onto the positioning seat; a control step for activating the system; three positioning steps that align the imprinting components with the hand tool; an imprinting step where the positioning seat rotates while the imprinting assembly moves repeatedly along the slide rail to create imprints; and a removal step where operations cease and the completed hand tool is removed. The present invention solves key problems of traditional imprinting technology by preventing workpiece displacement and deformation during the imprinting process.

### BACKGROUND OF THE INVENTION

### 1. Fields of the invention

The present invention relates to the technical field of imprinting devices, and more particularly, to a method for imprinting a hand tool and a device for the same.

### 2. Descriptions of Related Art

As shown in FIG. 9, the conventional hand tool imprinting device includes multiple rollers and steel printing blocks. The hand tool is placed on the rollers and rotates with the rollers, while the steel printing blocks apply pressure to the hand tool to create imprints. However, the aforementioned device has the following deficiencies:

Since there are no fixed parts between the rollers and the hand tool to prevent the hand tool from moving, as the rollers rotate, the imprints on the hand tool may become skewed, as shown in FIG. 9. Since the steel printing block applies pressure from above in a one-time manner, the hand tool may deform due to its hollow interior and excessive applied pressure, as shown in FIG. 10.

The present invention intends to provide a hand tool imprinting device and a method for creating imprints to a hand tool, so as to eliminate shortcomings mentioned above.

### SUMMARY OF THE INVENTION

The present invention relates to a hand tool imprinting device and comprises a base, a slide rail assembly located on a top of the base. The slide rail assembly has a slide rail and a sliding block, wherein the sliding block is slidably mounted on the slide rail. A positioning assembly includes a servo motor with an axial rod, and a positioning seat. The positioning seat is connected to a top of the axial rod. The servo motor drives and controls rotation of the axial rod and synchronously rotates the positioning seat. An imprinting assembly is located on a top of the sliding block and moves along with the sliding block. The imprinting assembly has a removable and replaceable imprinting piece, a telescopic arm, and a lifting member. The lifting member is located on the top of the sliding block. The lifting member is connected to one of two ends of the telescopic arm, and another one of the two ends of the telescopic arm is connected to the imprinting piece. The lifting member and the telescopic arm control the imprinting piece to move toward or away from the positioning assembly.

A control assembly includes a control module located therein. The control module is electrically connected to the slide rail assembly, the servo motor, and the imprinting assembly. The control module controls the movement of the sliding block along the slide rail, the rotation of the servo motor, the lifting of the lifting member, and the extension of the telescopic arm.

The present invention also provides a method for imprinting a hand tool, and the method comprises the following stesp:
a preliminary step: placing a hand tool on a positioning assembly located on a base, the positioning assembly including a servo motor with an axial rod and a positioning seat, the hand tool fitted onto the positioning seat;
a control step: activating a control assembly, the control assembly having a control module located therein, the control module controlling a movement path of a slide rail assembly, a lifting height of an imprinting assembly, and an extension distance of a telescopic arm of the imprinting assembly;
a first positioning step: using the control module to adjust the slide rail assembly, causing a sliding block of the slide rail assembly to move along a slide rail, and driving the imprinting assembly located on a top of the sliding block to move together corresponding to the hand tool;
a second positioning step: using the control module to adjust the imprinting assembly, causing a lifting member of the imprinting assembly to move up and down, and driving the telescopic arm to lift and relocate to the position corresponding to the hand tool;
   a third positioning step: using the control module to adjust the telescopic arm to extend toward a direction of the hand tool, causing the imprinting piece at one end of the telescopic arm to press against a surface of the hand tool;
   an imprinting step: after completing the above adjustment settings, using the control module to activate the servo motor to rotate the axial rod, the axial rod driving the positioning seat together with the hand tool to rotate, the control module simultaneously controlling the sliding block to move repeatedly along the slide rail, and the sliding block simultaneously driving the imprinting assembly to move repeatedly, cooperating with the servo motor indirectly driving the hand tool, so that the imprinting piece repeatedly imprints on the surface of the hand tool, and
   a removal step: after the imprinting piece imprinted on the surface of the hand tool in the above steps, the control module controlling the sliding block to stop moving, the servo motor to stop operating, and removing the completed imprinted hand tool from the positioning seat.

The primary object of the present invention is to provide a positioning assembly that allows the hand tool to be fixed in position without displacement during the imprinting process. At the same time, by providing support for the hand tool through the positioning seat, it is less likely to deform during imprinting. The present invention improves the deficiencies mentioned in the conventional technology regarding difficult positioning and easy deformation.

The advantages of the present invention lie in providing a place for mounting the hand tool during the imprinting process through the setup of the positioning assembly, thereby fixing its position. This can prevent the skewed imprints caused by the influence of roller rotation in the conventional technology, while also providing support for the hand tool to withstand the pressure created by the steel imprinting block during imprinting. Overall, it further improves the positioning and deformation problems of the conventional technology, demonstrating that the present invention indeed possesses practicality and progressiveness, making it worthy of industry promotion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is a perspective view of the present invention with a hand tool installed;

FIG. 3 is a partially enlarged view of FIG. 2 of the present invention;

FIG. 4 is another partially enlarged top view of FIG. 2 of the present invention;

FIG. 5 is a partially enlarged sectional view along line V-V of FIG. 2 of the present invention;

FIG. 6 is a shallow imprinting schematic diagram of the present invention;

FIG. 7 is a deep imprinting schematic diagram of the present invention;

FIG. 8A is a block diagram showing the relationship between the control module, the sensing module, and various components of the present invention;

FIG. 8B is a step block diagram of the present invention;

FIG. 9 is a schematic diagram showing hand tool displacement due to lack of fixed parts in the conventional imprinting device, and

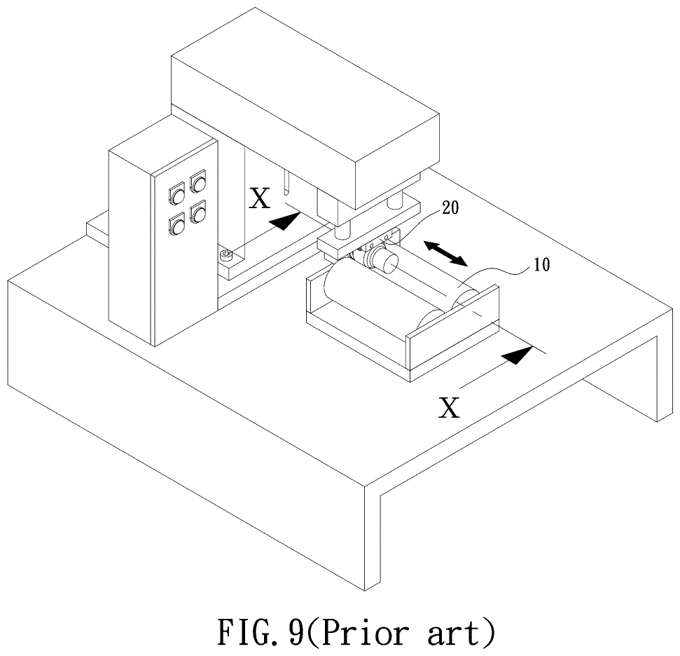

FIG. 10 is a schematic diagram showing hand tool deformation due to excessive one-time pressure application in the conventional imprinting device.

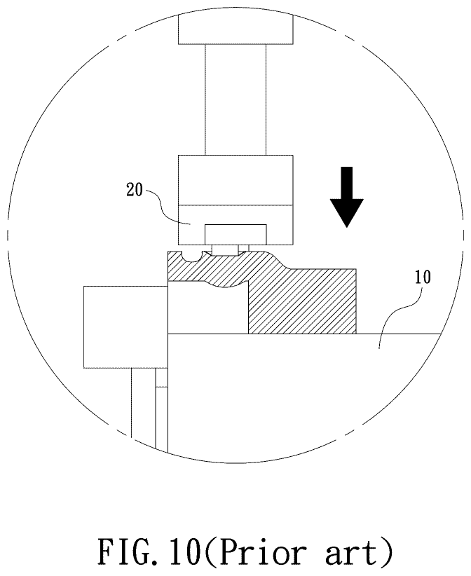

### DETAILED DESCRIPTION OF THE PREFERRED EMBODIMENT

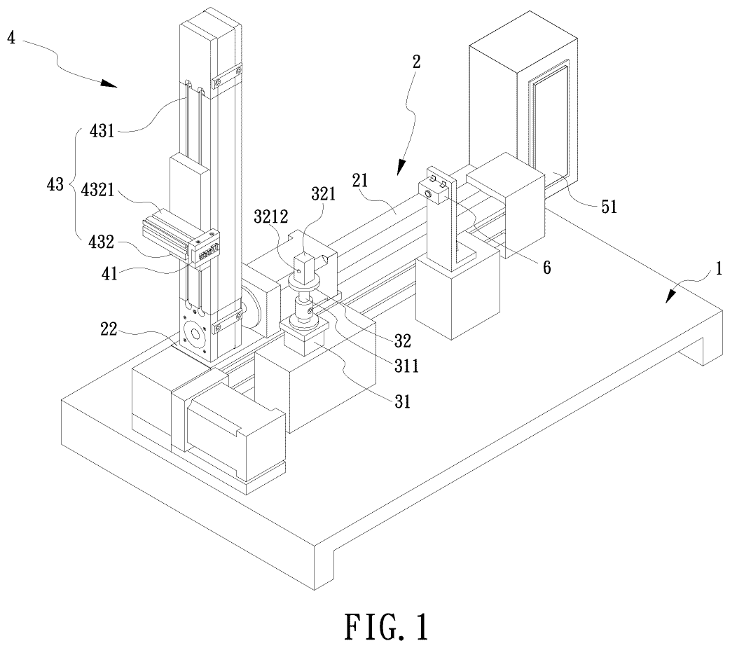

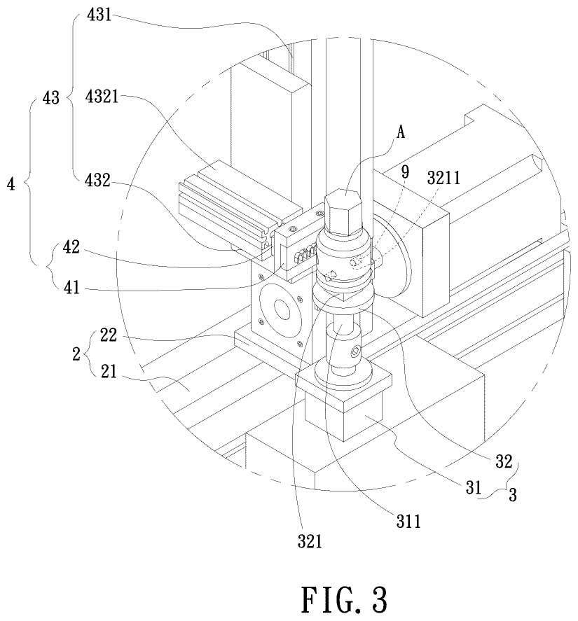

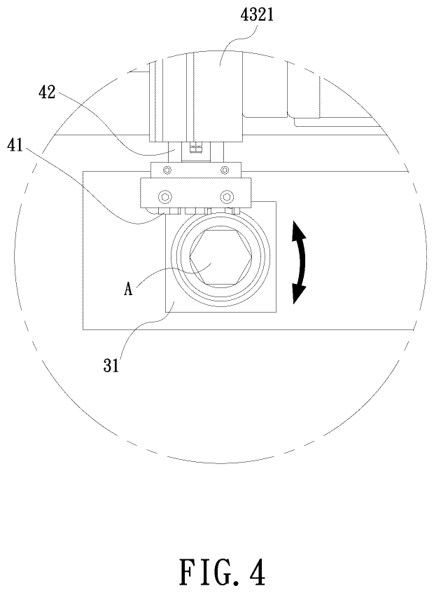

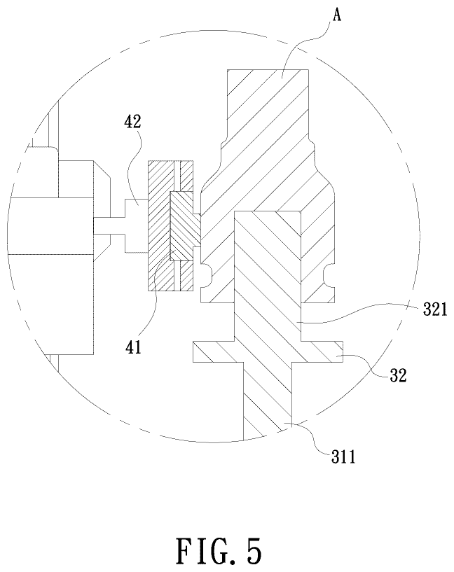

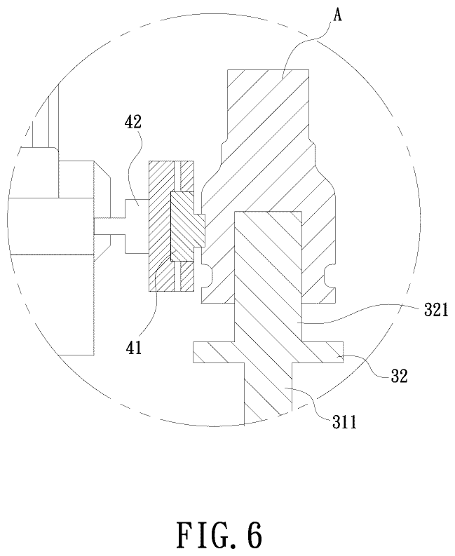

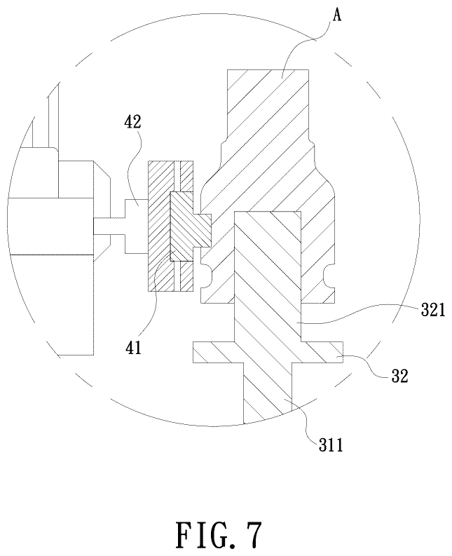

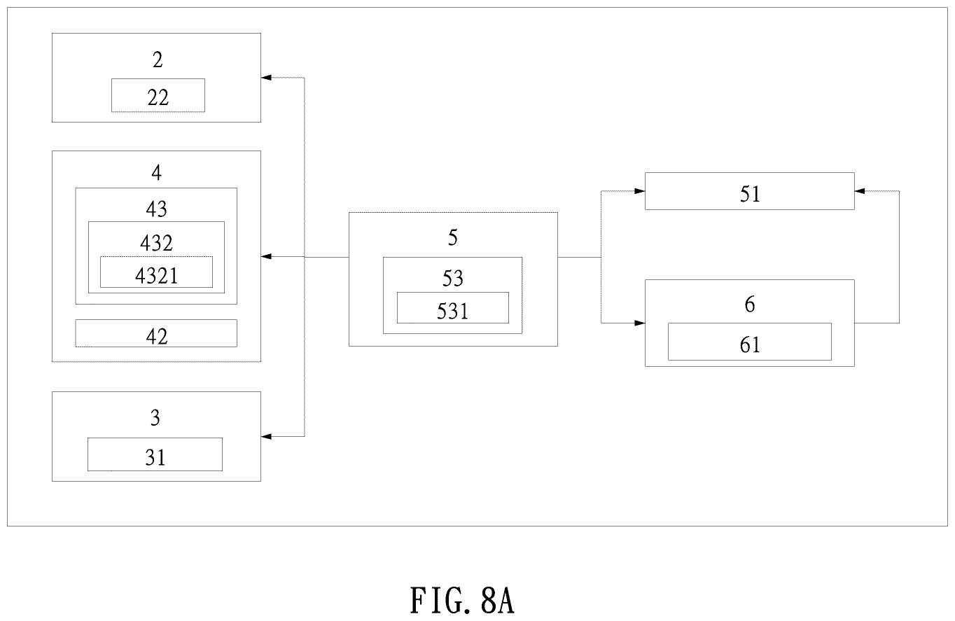

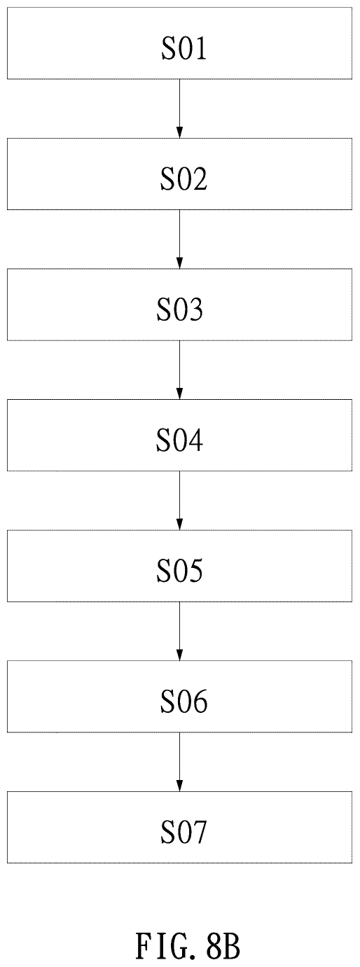

Referring to FIGS. 1 to 8B, the hand tool imprinting device of the present invention comprises a base 1, a slide rail assembly 2 located on a top of the base 1 and having a slide rail 21 and a sliding block 22, a positioning assembly 3 including a servo motor 31 with an axial rod 311 and a positioning seat 32, an imprinting assembly 4 located on a top of a sliding block 22 and moving along with the sliding block 22, and a control assembly 5. The sliding block 22 is slidably mounted on the slide rail 21. The positioning seat 32 is connected to a top of the axial rod 311. The servo motor 31 drives and controls rotation of the axial rod 311 and synchronously rotates the positioning seat 32. The imprinting assembly 4 has a removable and replaceable imprinting piece 41, a telescopic arm 42, and a lifting member 43. The lifting member 43 is located on the top of the sliding block 22. The lifting member 43 is connected to one of two ends of the telescopic arm 42, and another one of the two ends of the telescopic arm 42 is connected to the imprinting piece 41. The lifting member 43 and the telescopic arm 42 control the imprinting piece 41 to move toward or away from the positioning assembly 3. The control assembly 5 includes a control module 53 located therein. The control module 53 is electrically connected to the slide rail assembly 2, the servo motor 31, and the imprinting assembly 4. The control module 53 controls movement of the sliding block 22 along the slide rail 21, rotation of the servo motor 31, lifting of the lifting member 43, and extension of the telescopic arm 42 as shown in FIGS. 1, 2, 3 and 8A

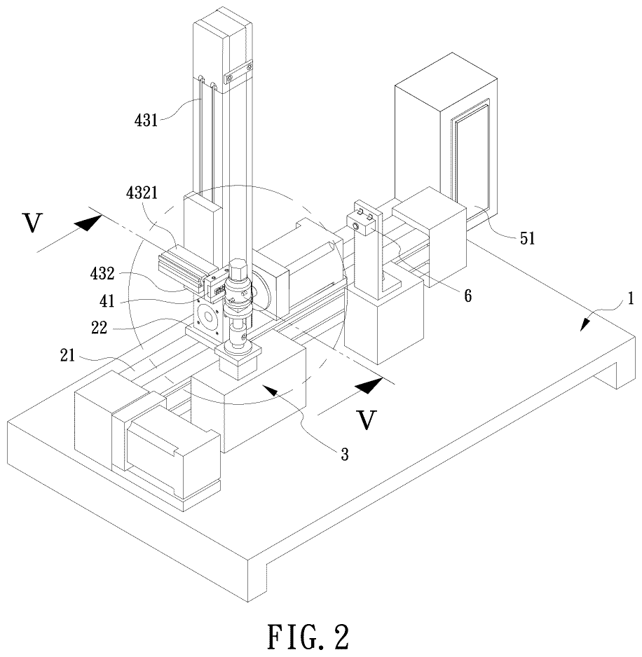

As shown in FIGS. 2 to 8B, the method for imprinting a hand tool of the present invention comprises:
a preliminary step S01: placing a hand tool “A” on a positioning assembly 3 located on a base 1, the positioning assembly 3 including a servo motor 31 with an axial rod 311 and a positioning seat 32, the hand tool “A” fitted onto the positioning seat 32;
a control step S02: activating a control assembly 5, the control assembly 5 having a control module 53 located therein, the control module 53 controlling a movement path of a slide rail assembly 2, a lifting height of an imprinting assembly 4, and an extension distance of a telescopic arm 42 of the imprinting assembly 4;
a first positioning step S03: using the control module 53 to adjust the slide rail assembly 2, causing a sliding block 22 of the slide rail assembly 2 to move along a slide rail 21, and driving the imprinting assembly 4 located on a top of the sliding block 22 to move together corresponding to the hand tool “A”;
a second positioning step S04: using the control module 53 to adjust the imprinting assembly 4, causing a lifting member 43 of the imprinting assembly 4 to move up and down, and driving the telescopic arm 42 to lift and relocate to the position corresponding to the hand tool “A”;”
   a third positioning step S05: using the control module 53 to adjust the telescopic arm 42 to extend toward a direction of the hand tool “A”, causing the imprinting piece 41 at one end of the telescopic arm 42 to press against a surface of the hand tool “A”;
   an imprinting step S06: after completing the above adjustment settings, using the control module 53 to activate the servo motor 31 to rotate the axial rod 311, the axial rod 311 driving the positioning seat 32 together with the hand tool “A” to rotate, the control module 53 simultaneously controlling the sliding block 22 to move repeatedly along the slide rail 21, and the sliding block 22 simultaneously driving the imprinting assembly 4 to move repeatedly, cooperating with the servo motor 31 indirectly driving the hand tool “A”, so that the imprinting piece 41 repeatedly imprint on the surface of the hand tool “A”, and
   a removal step S07: after the imprinting piece 41 imprinted on the surface of the hand tool “A” in the above steps, the control module 53 controlling the sliding block 22 to stop moving, the servo motor 31 to stop operating, and removing the completed imprinted hand tool “A” from the positioning seat 32.

To ensure that all imprinting positions remain consistent from beginning to end, the positioning seat 32 further has a fitting section 321. Any two corresponding outer surfaces of the fitting section 321 are each recessed with a positioning slot 3211. The positioning slot 3211 accommodates a positioning ball 3212, and the positioning ball 3212 interlocks with multiple positioning holes 9 of the hand tool “A”. Therefore, when fitting the hand tool “A” in the preliminary step S01, the multiple positioning holes 9 of the hand tool “A” are aligned with the respective positioning balls 3212 of the fitting section 321 to ensure that each positioning hole 9 properly interlocks with each positioning ball 3212. In addition, the shape of the fitting section 321 itself designed specifically for the hand tool “A” so as to achieve a double positioning effect. At the same time, the fitting section 321 of the positioning seat 32 provides support for the hand tool “A”, making the hand tool “A” less prone to deformation during imprinting to improve the deficiency of easy deformation in known technology, and the setup of the fitting section 321 of the positioning seat 32 solves the deficiency of hand tool “A” displacement during the imprinting process due to lack of fixed position in known technology, as shown in FIGS. 1, 2, 3, 8A, and 8B.

At the same time, a sensor device 6 is set up on one side of the base 1, the sensor device 6 is adjacent to the positioning assembly 3. The sensor device 6 is internally equipped with a sensing module 61, wherein the sensing module 61 is electrically connected to the control module 53. The sensing module 61 detects the position changes of each positioning ball 3212 as they rotate with the hand tool A during the imprinting process. In the imprinting step S06, by using the sensor device 6 to detect the position of the positioning ball 3212, whether it has completely rotated to the corresponding side along with the rotation of the positioning seat 32, this confirms whether the imprinting is complete, integrating the imprinting process with quality inspection, saving a processing step, as shown in FIGS. 1, 2, 3, 8A, and 8B.

Additionally, in order to accommodate various sizes of the hand tool “A”, the lifting member 43 further has a lifting slot 431 and a lifting seat 432. The lifting seat 432 has a pneumatic cylinder 4321, one end of the pneumatic cylinder 4321 of the lifting seat 432 is connected to the telescopic arm 42, and the other end of the lifting seat 432 moves up and down under the control of the control module 53 and slides within the lifting slot 431. The pneumatic cylinder 4321 controls the extension and retraction of the telescopic arm 42 under the control of the control module 53. In the control step S02, the first positioning step S03, the second positioning step S04, and the third positioning step S05, by adjusting the height of the lifting seat 432 and the extension distance of the telescopic arm 42, the area and depth of imprinting by the imprinting piece 41 corresponding to the hand tool “A” can be adjusted. In this way, in addition to adapting to a wider variety of sizes of the hand tool “A”, it is also possible to imprint at different positions and depths on the hand tool “A”, as shown in FIGS. 1, 2, 3, 4, 8A, and 8B.

Furthermore, the control assembly 5 has a screen display 51, the screen display 51 is electrically connected to the control module 53 and the sensing module 61. The control module further has a built-in setting unit 531, the screen display 51 displays the interface of the setting unit and sets or adjusts the sliding position and speed of the sliding block 22 on the slide rail 21, the rotation speed of the servo motor 31, the lifting position and speed of the lifting member 43, the extension distance of the telescopic arm 42, and the position changes of each positioning ball 3212. During the control step S02, through the screen display 51, it is possible to monitor or set the operating conditions of the sliding block 22, the servo motor 31, the lifting member 43, the telescopic arm 42, and each positioning ball 3212, keeping track of the imprinting situation at all times, effectively ensuring the smooth flow of the imprinting process, as shown in FIGS. 1 to 8B.

While we have shown and described the embodiment in accordance with the present invention, it should be clear to those skilled in the art that further embodiments may be made without departing from the scope of the present invention.

What is claimed is:

1. A hand tool imprinting device comprising:
a base;
a slide rail assembly located on a top of the base, the slide rail assembly having a slide rail and a sliding block, the sliding block slidably mounted on the slide rail;
a positioning assembly including a servo motor with an axial rod, and a positioning seat, the positioning seat connected to a top of the axial rod, the servo motor driving and controlling rotation of the axial rod and rotating the positioning seat;
an imprinting assembly located on a top of the sliding block and moving along with the sliding block, the imprinting assembly having an imprinting piece which is replaceable and movable, a telescopic arm, and a lifting member, the lifting member located on the top of the sliding block, the lifting member connected to one of two ends of the telescopic arm, another one of the two ends of the telescopic arm connected to the imprinting piece, the lifting member and the telescopic arm controlling the imprinting piece to move toward or away from the positioning assembly, and
a control assembly including a control module located therein, the control module electrically connected to the slide rail assembly, the servo motor, and the imprinting assembly, the control module controlling movement of the sliding block along the slide rail, rotation of the servo motor, lifting of the lifting member, and extension of the telescopic arm.

2. The method for imprinting a hand tool, comprising:
a preliminary step: placing a hand tool on a positioning assembly located on a base, the positioning assembly including a servo motor with an axial rod and a positioning seat, the hand tool fitted onto the positioning seat;
a control step: activating a control assembly, the control assembly having a control module located therein, the control module controlling a movement path of a slide rail assembly, a lifting height of an imprinting assembly, and an extension distance of a telescopic arm of the imprinting assembly;
a first positioning step: using the control module to adjust the slide rail assembly, causing a sliding block of the slide rail assembly to move along a slide rail, and driving the imprinting assembly located on a top of the sliding block to move together corresponding to the hand tool;
a second positioning step: using the control module to adjust the imprinting assembly, causing a lifting member of the imprinting assembly to move up and down, and driving the telescopic arm to lift and relocate to the position corresponding to the hand tool;
a third positioning step: using the control module to adjust the telescopic arm to extend toward a direction of the hand tool, causing the imprinting piece at one end of the telescopic arm to press against a surface of the hand tool;
an imprinting step: after completing the above adjustment settings, using the control module to activate the servo motor to rotate the axial rod, the axial rod driving the positioning seat together with the hand tool to rotate, the control module controlling the sliding block to move repeatedly along the slide rail, and the sliding block driving the imprinting assembly to move repeatedly, cooperating with the servo motor indirectly driving the hand tool, so that the imprinting piece repeatedly imprints on the surface of the hand tool, and
a removal step: after the imprinting piece imprinted on the surface of the hand tool in the above steps, the control module controlling the sliding block to stop moving, the servo motor to stop operating, and removing the completed imprinted hand tool from the positioning seat.

3. The method as claimed in claim 2, wherein the positioning seat has a fitting section, each of any two corresponding outer surfaces of the fitting section includes a positioning slot, the positioning slot accommodates a positioning ball, the positioning ball interlocks with multiple positioning holes of the hand tool.

4. The method as claimed in claim 3 further comprising a sensor device, the sensor device located adjacent to the positioning assembly, the sensor device internally equipped with a sensing module, the sensing module electrically connected to the control module, the sensing module detecting position changes of each positioning ball as each positioning ball rotates with the hand tool during imprinting.

5. The method as claimed in claim 4, wherein the control assembly has a screen display which is electrically connected to the control module and the sensing module, the control module has a built-in setting unit, the screen display displays an interface of the setting unit, and sets or adjusts sliding position and speed of the sliding block on the slide rail, a rotation speed of the servo motor, a lifting position and speed of the lifting member, and an extension distance of the telescopic arm.

6. The method as claimed in claim 2, wherein the lifting member has a lifting slot and a lifting seat, the lifting seat has a pneumatic cylinder, one of two ends of the pneumatic cylinder of the lifting seat is connected to the telescopic arm, another one of the two ends of the lifting seat moves up and down by the control module, and slides within the lifting slot, the pneumatic cylinder extends and retracts the telescopic arm by the control module.
